(19) United States
(12) Patent Application Publication
(10) Pub. No.: US 2026/0251534 A1
(43) Pub. Date: Aug. 27, 2026

(54) MECHANISM EQUIVALENCE-DRIVEN METHOD FOR DEGRADATION STAGES IDENTIFICATION AND CHANGE POINTS DETECTION

(71) Applicant: Beihang University, Beijing (CN)

(72) Inventors: Han WANG, Beijing (CN); Jiayue WU, Beijing (CN); Haodi JI, Beijing (CN); Xiaobing MA, Beijing (CN)

(21) Appl. No.: 19/649,227

(22) Filed: Apr. 16, 2026

(30) Foreign Application Priority Data
May 13, 2025 (CN) 202510613796.6

(51) Int. Cl. G01M 99/00; G06F 17/13

(52) U.S. Cl. CPC G01M 99/005; G06F 17/13

(57) ABSTRACT

The present disclosure discloses a mechanism equivalence-driven method for degradation stage identification and change point detection, which belongs to the field of product performance degradation modeling and life prediction technology, comprising S1, preprocessing degradation data of a product and dividing degradation phases; S2, calculating a mechanical equivalence factor (MEF) of each degradation phase; S3, constructing hypothesis testing samples and performing normality test on the samples; S4, performing test for equivalence of variances and means; S5, determining failure mechanism change points and identifying degradation stages; the present disclosure provides a mechanism equivalence-driven method for degradation stage identification and change point detection, based on the theory of mechanism equivalence degradation modeling, the Tweedie exponential dispersion process (TEDP) is used to model the product degradation process, aiming to improve the accuracy and reliability of degradation stages identification and change points detection.

### TECHNICAL FIELD

The present disclosure relates to the technical field of product performance degradation modeling and life prediction, in particular, to a mechanism equivalence-driven method for degradation stages identification and change points detection.

### BACKGROUND

A product typically exhibits multiple failure modes, each associated with a specific failure mechanism. Since the product may be subjected to different stress levels during operation, any change in its failure mechanism will result in a corresponding change in its failure process. When using degradation data for fault diagnosis and life prediction, it is essential to ensure that the failure mechanism remains stable to guarantee the validity of the inference; otherwise, conclusions drawn from extrapolation will not accurately reflect the product's reliability performance.

In recent years, stochastic process-based degradation modeling has been extensively studied to gain deeper insights into the degradation patterns of mechanical components. Most research has focused on three types of processes: the Wiener process, the Gamma process, and the inverse Gaussian process. However, in certain engineering applications, these three models may be inadequate and exhibit certain limitations. Moreover, if the true degradation process does not fall within these three candidate models, reliability analysis results based on them may be unsatisfactory. Therefore, a more general degradation model is needed to describe the actual degradation process more accurately. The Tweedie exponential dispersion process (TEDP) encompasses the most commonly used Wiener, Gamma, and inverse Gaussian processes as special cases, offering superior generality and gaining widespread attention in the field of performance degradation modeling. Compared to other models, TEDP provides greater flexibility in characterizing degradation processes and improves the accuracy of reliability analysis.

Building on this, the present disclosure proposes a mechanism equivalence-driven method for degradation stages identification and change points detection. This method employs a highly general degradation model to accurately model product degradation data and incorporates a mechanism equivalence condition testing procedure to enable change-point detection of degradation mechanisms and identification of degradation stages.

### SUMMARY

An objective of this present disclosure is to provide a mechanism equivalence-driven method for degradation stages identification and change points detection, so as to address the problems existing in the background art regarding traditional product performance degradation modeling and life prediction methods, such as unclear failure mechanisms, weak model universality, and low life prediction accuracy.

To achieve the above objective, the present disclosure provides a mechanism equivalence-driven method for degradation stages identification and change points detection, based on following basic settings:
Setting 1: A signal collected by a sensor may reflect a degradation amount of a product, and the degradation amount is affected by a degradation mechanism.
Setting 2: The products under each degradation phase belong to a same batch, and elements in a mechanical equivalence factor (MEF) vector sample of each degradation phase come from a same distribution population. It is assumed that different elements are independent of each other, and there is no correlation between different distribution populations.

This includes the following steps:
S1, Preprocessing degradation data of a product and dividing degradation phases;
S2, calculating the MEF of each degradation phase;
S3, constructing hypothesis testing samples and performing a normality test on the samples;
S4, performing test for equivalence of variances and means;
S5, determining failure mechanism change points and identifying degradation stages.

In some embodiments, step S1 specifically includes:
It is assumed that degradation data of n products are collected and divided into k degradation phases according to time series, each degradation phase is measured c times, h=1, 2, . . . , c; the degradation phase is denoted as i, i=1, 2, . . . , k, a product serial number is denoted as j, j=1, 2, . . . , n, a historical monitoring time and a corresponding degradation path are denoted as T_{0→x}={t₀, t₁, . . . , tₓ} and Y_{0→x}={y₀, y₁, . . . , yₓ}, respectively, where tₓᵢ denotes a start or end time of each degradation phase, and yₓᵢ=Y (tₓᵢ);
To ensure that the data used in subsequent modeling and calculations are valid, preprocessing is required to guarantee that the data are monotonically increasing. Before data preprocessing, time-domain or frequency-domain features may also be extracted to more effectively reflect a product degradation process. The present disclosure employs isotonic regression and a single exponential smoothing method, the isotonic regression yields dependent variable values that satisfy a non-decreasing constraint without altering an order of independent variables. A statistical estimator for isotonic regression does not have an explicit expression but can be solved through programming; the single exponential smoothing method provides a predicted value at time t+1 by computing a weighted average of an actual observation value and a predicted value at time t, with a prediction formula given as follows:

$${F}_{t + 1} = ε {Y}_{t} + ( 1 - ε ) {F}_{t} \qquad ( 1 )$$

where Yₜ denotes the actual observation value at time t; Fₜ denotes the predicted value at time t; ε denotes a smoothing coefficient.

In some embodiments, step S2 specifically includes:
S21, a degradation model is performed based on a Tweedie exponential dispersion process (TEDP) according to the degradation data;
S22, a definition of MEF is obtained by combining an accelerating factor invariant principle with the TEDP process;
S23, a large number of sample data and a complexity of the model form are taken into consideration, and a maximum likelihood estimation method is used to estimate parameters required for calculating the MEF.

In some embodiments, step S21 is specified as follows: Let {Y(t), t≥0} be an observed product degradation path, and let Δtᵢ=tᵢ−tᵢ₋₁ along with Δyᵢ=yᵢ−yᵢ₋₁, due to a complexity of a TEDP model, a distribution of degradation increment f(Δy; μ, λ, r) has no exact analytical expression. However, a saddle-point approximation method is used, an approximate expression for the degradation increment f(Δy; μ, λ, r) when ΔΔt→∞ is given by:

$$f ( Δ y ; μ , λ ) = c ( Δ y ; λ , Δ t ) \cdot exp \{ λ [ Δ y \cdot ω ( μ ) - Δ t \cdot κ ( ω ( μ ) ) ] \} \qquad ( 2 )$$

where μ denotes a drift parameter, λ denotes a diffusion parameter, c(⋅) and κ(⋅) are real functions, and a mean and variance of Y(t) are μt and V(μ)t/λ, respectively, where p=κ′(W(u)), V(μ)=κ″(ω(μ)), and ω′(μ)=1/V(μ); in particular, V(μ)=μ^{r}, with r∈(−∞, 0]∪[1, ∞), is defined as a variance function, and d(Δy; Δt, μ, r) denotes a unit deviation function, which is calculated using following equations:

$$d ( Δ y ; Δ t , μ , r ) = \{ \begin{matrix}{( \frac{Δ y}{Δ t} - μ )}^{2} , r = 0 \\ 2 [ \frac{Δ y}{Δ t} log ( \frac{Δ y}{μΔ t} ) - ( \frac{Δ y}{Δ t} - μ ) ] , r = 1 \\ 2 [ log ( \frac{μΔ t}{Δ y} ) + \frac{Δ y}{μΔ t} - 1 ] , r = 2 \\ 2 \{ \frac{[ {max ( Δ y / Δ t , 0 )}^{2 - r} ]}{( 1 - r ) ( 2 - r )} - \frac{{μ}^{1 - r} Δ y}{( 1 - r ) Δ t} + \frac{{μ}^{2 - r}}{2 - r} \} , r \neq 0 , 1 , 2\end{matrix} . \qquad ( 3 )$$

In some embodiments, in step S22, the accelerating factor invariant principle is one of the most commonly used statistical principles in engineering applications, its basic idea is that when a failure mechanism remains unchanged during an accelerated test, an engineering-applicable acceleration factor is determined solely by a stress level and is independent of product's operating time or reliability value. By combining the accelerating factor invariant principle with the TEDP process and carrying out a series of derivations, the MEF can be defined as follows:

$$m = \frac{λ}{{μ}^{r - 1}} . \qquad ( 4 )$$

When the degradation mechanism remains unchanged, the MEF should theoretically be a constant in the degradation process. According to Equation (4), once parameters μ, r, and λ are estimated, m can be obtained.

In some embodiments, a log-likelihood function of the product degradation path in step S23 is:

$$ln L ( ϒ , Θ ) = {\sum }_{i = 1}^{k} {\sum }_{j = 1}^{n} {\sum }_{h = 1}^{c} Inf ( Δ {y}_{ijh} ; {μ}_{i} , {λ}_{i} , {r}_{i} ) = {\sum }_{i = 1}^{k} ( \frac{n c}{2} ln \frac{λ}{2 π} ) - {\sum }_{i = 1}^{k} {\sum }_{j = 1}^{n} {\sum }_{h = 1}^{c} ( \frac{1 - r}{2} ln Δ {t}_{ijh} + \frac{r}{2} ln Δ {y}_{ijh} ) - {\sum }_{i = 1}^{k} {\sum }_{j = 1}^{n} {\sum }_{h = 1}^{c} ( \frac{{λ}_{i} Δ {t}_{ijh}}{2} d ( Δ {y}_{ijh} ; Δ {t}_{ijh} , {μ}_{i} ) ) \qquad ( 5 )$$

By calculating a partial derivative of Equation (5), estimation equations of parameters μᵢ and λᵢ are obtained:

$${\hat{μ}}_{i} = \frac{{\sum }_{j = 1}^{n} {\sum }_{h = 1}^{c} Δ {y}_{ijh}}{{\sum }_{j = 1}^{n} {\sum }_{h = 1}^{c} Δ {t}_{ijh}} \qquad ( 6 )$$

$${\hat{λ}}_{i} = \frac{nc}{{\sum }_{j = 1}^{n} {\sum }_{h = 1}^{c} Δ {t}_{ijh} d ( Δ {y}_{ijh} ; Δ {t}_{ijh} , {\hat{μ}}_{i} )} \qquad ( 7 )$$

\hat{μ}ᵢ and \hat{λ}ᵢ are substituted into Equation (5), its maximum extreme point is solved, and \hat{r}ᵢ is obtained.

In some embodiments, step S3 specifically includes:

In practical applications, due to an influence of random factors on engineering data, the obtained MEF is a random variable. Parameters of each phase and each product are estimated, respectively, and a MEF vector sample is constructed as follows:

$${\hat{M}}_{i} = ( {\hat{M}}_{i 1} , {\hat{M}}_{i 2} , ⋯ , {\hat{M}}_{i n} ) \qquad ( 8 )$$

Where \hat{M}ᵢⱼ denotes a MEF for an i-th degradation phase estimated based on a j-th product, let \hat{M}₁, . . . , \hat{M}ᵢ, . . . , \hat{M}ₖ be the hypothesis testing samples. Since the products within each degradation phase belong to a same batch, elements in the vector \hat{M}ᵢ are considered to come from a same population distribution, and it is assumed that the elements are independent of each other, and there is no correlation between different population distributions. Based on the above assumptions, the means and variances are used to test whether there are significant differences between different population distributions, thereby determining whether the degradation mechanism has changed;

There are many ways to test whether the sample obeys a normal distribution. In this method, several elements in each degradation phase are small due to cost constraints. Therefore, consider a Shapiro-Wilk (S-W) test that performs well in small sample sizes. The S-W test in SPSS software is used to test whether \hat{M}ᵢ₁, \hat{M}ᵢ₂, . . . , \hat{M}ᵢₙ obey the normal distribution.

In some embodiments, step S4 specifically includes:
When the S-W test is accepted, \hat{M}ᵢ₁, \hat{M}ᵢ₂, . . . , \hat{M}ᵢₙ are considered to follow the normal distribution, degradation phases that do not pass the S-W test are removed, and remaining samples are tested for mechanism equivalence. For an i-th degradation phase that follows the normal distribution, an unbiased estimation of mean and variance is obtained by using following equations, where i=1, 2, . . . , k′:

$${\overline{p}}_{i} = \frac{1}{n} {\sum }_{j = 1}^{n} {\hat{M}}_{ij} \qquad ( 9 )$$

$${\overline{q}}_{i}^{2} = \frac{1}{n - 1} {\sum }_{j = 1}^{n} {( {\hat{M}}_{ij} - {p}_{i} )}^{2} \qquad ( 10 )$$

Further test whether distributions of the samples of the MEF vector from different degradation phases are equivalent; firstly, a Bartlett test is used to evaluate a variance equivalence, Bartlett statistic has been proved to be suitable for testing whether there is a significant difference in variances under different normal distribution populations (statistic falls into a rejection region indicates that there is a significant difference). A null hypothesis of equal variance is denoted as

$${H}_{0} : {q}_{1}^{2} = {q}_{2}^{2} = ⋯ = {q}_{k}^{2} ,$$

and the Bartlett statistic is constructed as:

$$B = \frac{v ln ( {\overline{q}}^{2} ) - {\sum }_{i = 1}^{k} {v}_{i} ln ( {\overline{q}}_{i}^{2} )}{1 + \frac{1}{3 ( k - 1 )} ( {\sum }_{i = 1}^{k} \frac{1}{{v}_{i}} - \frac{1}{v} )} \qquad ( 11 )$$

Where

$${\overline{q}}^{2} = [ {\sum }_{i = 1}^{k} {v}_{i} {\overline{q}}_{i}^{2} ] / v , {v}_{i} = n - 1 , v = {\sum }_{i = 1}^{k} {v}_{i} .$$

At a significance level a, the rejection region is:

$${Ω}_{Bart} = \{ B \geq {χ}_{α}^{2} ( k - 1 ) \} \qquad ( 12 )$$

Although the Bartlett test can efficiently test whether there are significant differences in multiple phases, when the null hypothesis is rejected, the Bartlett test cannot provide information to determine the degradation phase corresponding to a change in the degradation mechanism. In this case, an F test can be performed sequentially between adjacent degradation phases until a specific location of the degradation mechanism change is determined.

Subsequently, analysis of variances (ANOVA) is used to test the equivalence of the mean values of the samples within each degradation phase, but it should be noted that one of prerequisites for the ANOVA test is that the variances between the groups are equal, that is, an assumption of homoscedasticity. If the F test finds that there are significant differences in the variances of some phases, then a direct use of ANOVA for the mean test may affect a validity of the results. At this time, a Welch ANOVA method can be used to test the equivalence of the means. The Welch ANOVA is an improved analysis of variance method, which does not require the variances of each group to be consistent. By calculating a p-value of Welch ANOVA, it is judged whether there is a significant difference in the mean value of each degradation phase.

In some embodiments, in step S5, the means and variances of the MEF vector samples obtained in S4 under different degradation phases are compared, if there is a significant difference between overall distributions of the means or variances, it is considered that the degradation mechanism of the product in one or several degradation phases has changed; otherwise, it is considered that the degradation mechanism of the product has not changed. Based on this, a location of the mechanism change-point is determined, and degradation stages under different degradation mechanisms are identified.

Therefore, the present disclosure adopts the above-mentioned mechanism equivalence-driven method for degradation stages identification and change points detection, which has following beneficial effects:
(1) The TEDP process is used to model the product degradation process, which enhances an universality of the model, ensures an accuracy of the modeling, and makes the model more in line with real-world degradation behavior;
(2) the mechanism equivalence testing method based on the parameters of the degradation model can accurately and quickly detect the change-point of the degradation mechanism and identify the degradation stage by checking whether the model parameters meet the failure mechanism equivalence conditions. This method does not require a complex calculation process, it enables precise determination using only the degradation data obtained from experiments, offering high operability and convenience;
this method has a low requirement for amount of degradation data, demonstrating its superiority in handling small sample data;
the technical scheme of the present disclosure is further described in detail below with reference to the drawings and embodiments.

### BRIEF DESCRIPTION OF THE DRAWINGS

FIG. 1 is a flow chart of the mechanism equivalence-driven method for degradation stages identification and change points detection;

FIGS. 2a-2e are schematic diagrams of the original vibration signal data of the five wheels of the embodiment of the present disclosure, where FIG. 2a is wheel 1, FIG. 2b is wheel 2, FIG. 2c is wheel 3, FIG. 2d is wheel 4, FIG. 2e is wheel 5;

FIG. 3 is a schematic diagram of the mean feature extraction signal of the wheel 1 of the embodiment of the present disclosure;

FIG. 4 is a schematic diagram of the wheel 1 of data after preprocessing of the embodiment of the present disclosure.

### DETAILED DESCRIPTION

The following detailed description of the embodiment of the present disclosure provided in the drawings is not intended to limit the scope of the present disclosure requiring protection, but merely indicates the selected embodiment of the present disclosure. Based on the embodiments in this present disclosure, all other embodiments obtained by ordinary technicians in this field without making creative labor belong to the scope of protection of this present disclosure.

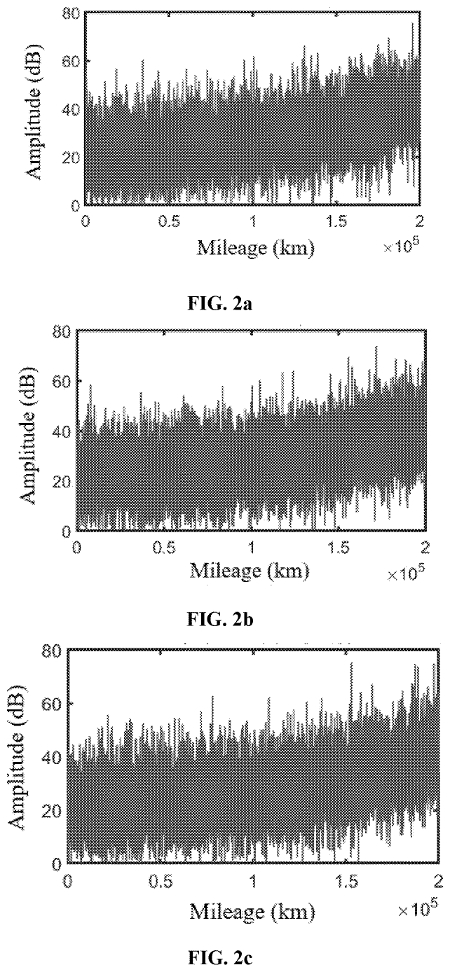

In this embodiment, the wheel degradation data of a high-speed train running in China are obtained. A condition monitoring system is installed on the wheel, which consists of four sensors and a processor. With the passage of time, due to material defects and workload, small cracks may appear under the wheel surface, resulting in fatigue cracks on the surface. When the defective area of the wheel is in contact with the railway, the vibration signal collected by the sensor can be used to track the degradation process of the wheel. The vibration value of its wheels is measured every 20 kilometers at a distance of 200,000 kilometers of train operation. A total of 5 wheel vibration data points are collected on the same train, as shown in FIG. 2. According to the mechanism equivalence-driven method for degradation stages identification and change points detection proposed in this disclosure, the Tweedie exponential dispersion process (TEDP) degradation model of the wheel is established, and the degradation mechanism change-point and the degradation stage are predicted.

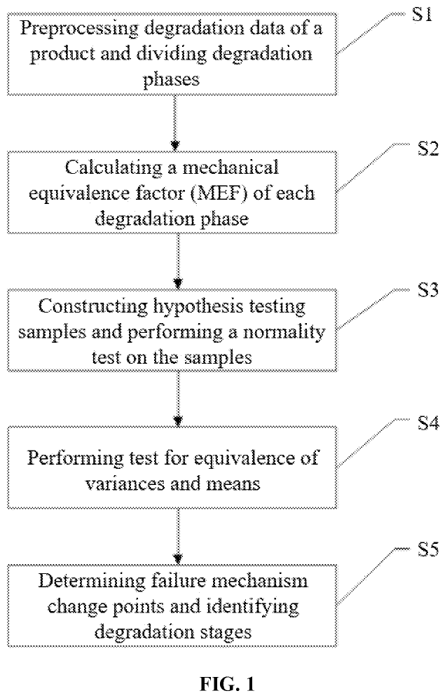

As shown in FIG. 1, a mechanism equivalence-driven method for degradation stages identification and change points detection includes the following steps:

### S1, Degradation Data of the Product are Preprocessed, and Degradation Phases are Divided

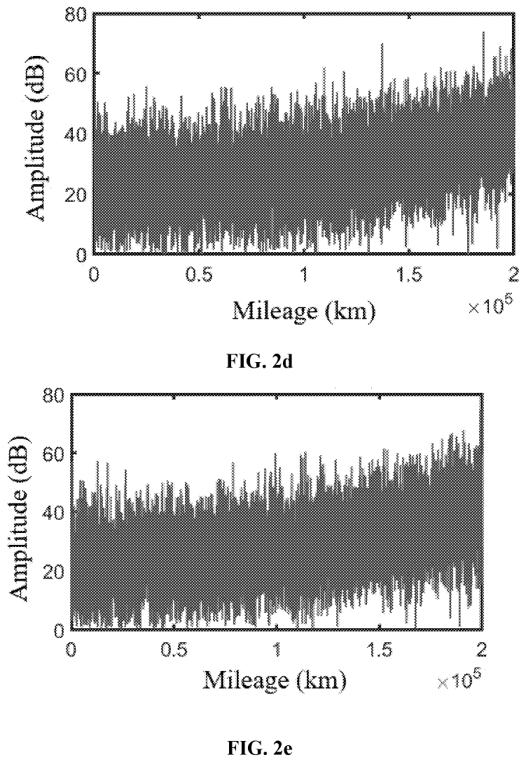

Due to the large number of data points and the presence of noise, feature extraction is performed before data preprocessing. Considering that the acquired data are measured at a relatively sparse sampling frequency, this embodiment uses time-domain features to reflect the data state. It is found through calculation that the mean feature may better capture the monotonic trend of the data compared with other features. For each wheel, 100 feature data points are obtained by extracting the mean value from every 100 raw data points in chronological order from the total of 10,000 data points. Taking wheel 1 as an example, the result of mean feature extraction is shown in FIG. 3. The extracted feature signals for the remaining four wheels are similar.

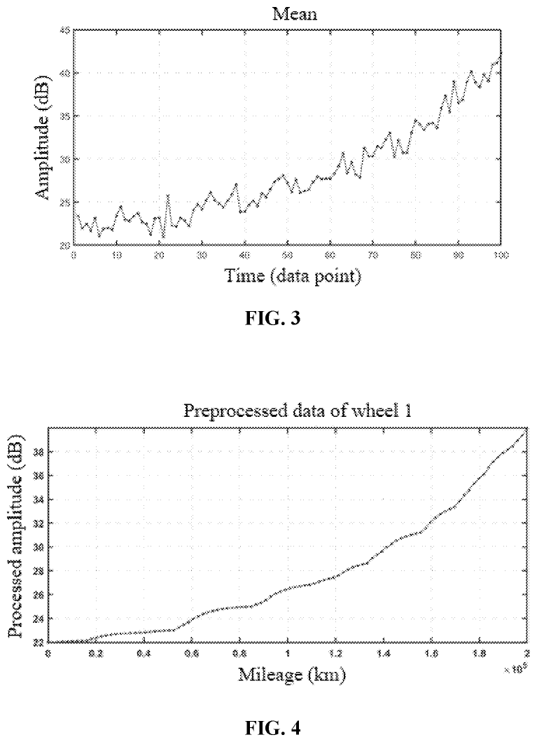

Next, the data are preprocessed to ensure monotonic increase. Firstly, isotonic regression is performed on the data, which can be implemented using MATLAB software. At this stage, the data do not yet exhibit a monotonic increase, so exponential smoothing is further applied. In this embodiment, the smoothing coefficient C is set to 0.2, which ensures data smoothness. The data of wheel 1 after preprocessing are shown in FIG. 4, and the extracted feature signals for the remaining four wheels are similar.

For the processed data, the accuracy of the degradation phase division is determined according to the actual needs of the project. The present disclosure divides 100 feature data of each wheel into 10 degradation phases, which is equivalent to measuring ten times in a degradation phase, and the corresponding parameters are: n=5, k=10, c=10.

### S2, the Mechanical Equivalence Factor (MEF) of Each Degradation Phase is Calculated

The data of the five wheels are substituted into Equations (5), (6), and (7) to obtain the parameters \hat{μ}ᵢ, \hat{λ}ᵢ, and \hat{r}ᵢ. The estimated value \hat{m}ᵢ of the MEF is obtained by using Equation (4). The estimation results of all parameters are shown in Table 1.

TABLE 1
Parameter estimation results
Degradation phase k

| | | 1 | 2 | 3 | 4 | 5 | 6 | 7 | 8 | 9 | 10 |
|---|---|---|---|---|---|---|---|---|---|---|---|
| Wheel 1 | \hat{μ} | 0.037 | 0.053 | 0.086 | 0.127 | 0.147 | 0.102 | 0.220 | 0.243 | 0.370 | 0.422 |
| | \hat{r} | 3.282 | 2.453 | 3.002 | 2.453 | 1.351 | 1.678 | 2.062 | 2.028 | 0.574 | 1.302 |
| | \hat{λ} | 0.015 | 0.621 | 0.049 | 0.920 | 6.501 | 18.109 | 4.720 | 3.370 | 32.091 | 25.993 |
| | \hat{m} | 0.036 | 0.023 | 0.149 | 0.054 | 0.079 | 0.012 | 0.042 | 0.069 | 0.048 | 0.030 |
| Wheel 2 | \hat{μ} | 0.060 | 0.029 | 0.120 | 0.086 | 0.135 | 0.129 | 0.205 | 0.291 | 0.356 | 0.379 |
| | \hat{r} | 2.388 | 2.462 | 1.048 | 2.479 | 3.921 | 3.221 | 1.278 | 2.766 | 1.572 | 2.531 |
| | \hat{λ} | 1.202 | 0.458 | 16.021 | 1.437 | 0.315 | 0.242 | 13.844 | 1.754 | 9.735 | 3.727 |
| | \hat{m} | 0.017 | 0.012 | 0.056 | 0.018 | 0.009 | 0.044 | 0.046 | 0.064 | 0.057 | 0.061 |
| Wheel 3 | \hat{μ} | 0.031 | 0.081 | 0.071 | 0.120 | 0.100 | 0.189 | 0.191 | 0.273 | 0.318 | 0.486 |
| | \hat{r} | 1.745 | 3.255 | 2.203 | 1.228 | 1.172 | 0.192 | 2.925 | 4.139 | 1.882 | 2.498 |
| | \hat{λ} | 14.445 | 0.254 | 6.030 | 22.799 | 70.043 | 111.314 | 1.157 | 0.488 | 6.900 | 10.121 |
| | \hat{m} | 0.005 | 0.014 | 0.007 | 0.027 | 0.010 | 0.035 | 0.036 | 0.035 | 0.053 | 0.034 |
| Wheel 4 | \hat{μ} | 0.040 | 0.038 | 0.074 | 0.138 | 0.097 | 0.131 | 0.273 | 0.273 | 0.315 | 0.428 |
| | \hat{r} | 3.328 | 1.552 | 0.922 | 2.002 | 2.794 | 2.467 | 2.431 | 1.060 | 1.636 | 1.204 |
| | \hat{λ} | 0.034 | 32.087 | 51.546 | 3.753 | 0.396 | 1.223 | 10.300 | 36.591 | 7.595 | 9.834 |
| | \hat{m} | 0.016 | 0.005 | 0.024 | 0.037 | 0.038 | 0.042 | 0.015 | 0.025 | 0.063 | 0.085 |
| Wheel 5 | \hat{μ} | 0.064 | 0.090 | 0.084 | 0.088 | 0.122 | 0.099 | 0.239 | 0.304 | 0.277 | 0.453 |
| | \hat{r} | 2.493 | 2.014 | 3.031 | 2.251 | 2.445 | 2.473 | 0.830 | 8.510 | 1.227 | 1.508 |
| | \hat{λ} | 2.497 | 1.674 | 1.374 | 0.783 | 0.806 | 1.258 | 94.538 | 0.012 | 20.845 | 14.586 |
| | \hat{m} | 0.007 | 0.052 | 0.005 | 0.061 | 0.059 | 0.026 | 0.013 | 0.011 | 0.036 | 0.046 |

### S3, Hypothesis Testing Samples are Constructed, and the Normality of the Samples is Tested

Based on the estimation results of \hat{m}ᵢ in Table 1, the hypothesis testing samples \hat{M}₁-\hat{M}₁₀ are constructed as follows:

$${\hat{M}}_{1} = ( 0.036 , 0.017 , 0.005 , 0.016 , 0.0 \; 07 ) ;$$

$${\hat{M}}_{2} = ( 0.023 , 0.012 , 0.014 , 0.005 , 0.0 \; 52 ) ;$$

$${\hat{M}}_{3} = ( 0.149 , 0.056 , 0.007 , 0.024 , 0.0 \; 05 ) ;$$

$${\hat{M}}_{4} = ( 0.054 , 0.018 , 0.027 , 0.037 , 0.0 \; 61 ) ;$$

$${\hat{M}}_{5} = ( 0.079 , 0.009 , 0.010 , 0.038 , 0.0 \; 59 ) ;$$

$${\hat{M}}_{6} = ( 0.012 , 0.044 , 0.035 , 0.042 , 0.026 ) ;$$

$${\hat{M}}_{7} = ( 0.042 , 0.046 , 0.036 , 0.015 , 0.0 \; 13 ) ;$$

$${\hat{M}}_{8} = ( 0.069 , 0.064 , 0.035 , 0.025 , 0.011 ) ;$$

$${\hat{M}}_{9} = ( 0.048 , 0.057 , 0.053 , 0.063 , 0.0 \; 36 ) ;$$

$${\hat{M}}_{10} = ( 0.030 , 0.061 , 0.034 , 0.085 , 0.046 ) ;$$

this embodiment uses the S-W test function in SPSS software to test whether \hat{M}ᵢ₁, \hat{M}ᵢ₂, . . . , \hat{M}ᵢₙ obey the normal distribution, the Shapiro-Wilk (S-W) test is performed on each hypothesis testing sample, and all samples pass the test, indicating that the data group obeys the normal distribution and meets the conditions of subsequent tests.

### S4, the Equivalence of Variance and Mean is Tested

Bartlett is first used to test the variance consistency of these normal distributions. The Bartlett statistics of ten phases are calculated by taking the significance parameter α=0.05.

$$B = 21.59 > {χ}_{0.05}^{2} ( 9 ) = 16.919 ;$$

the Bartlett statistic falls into the rejection region, indicating that there are significant differences in the variances of the MEF estimates across the ten degradation phases. To identify the degradation phases corresponding to changes in the degradation mechanism, F-tests are performed pairwise between adjacent degradation phases, the test results are shown in Table 2.

TABLE 2
Test results

| Test phase | p-value in F-test | Result |
|---|---|---|
| k = 1 and k = 2 | 0.45374 | Accept |
| k = 2 and k = 3 | 0.041756 | Reject |
| k = 3 and k = 4 | 0.038858 | Reject |
| k = 4 and k = 5 | 0.32936 | Accept |
| k = 5 and k = 6 | 0.12997 | Accept |
| k = 6 and k = 7 | 0.76355 | Accept |
| k = 7 and k = 8 | 0.37011 | Accept |
| k = 8 and k = 9 | 0.11067 | Accept |
| k = 9 and k = 10 | 0.15686 | Accept |

Due to the unequal variance, the Welch ANOVA method is used to test the equivalence of the means, and the test results are shown in Table 3.

TABLE 3
Welch ANOVA test results

| Test phase | p-value in the Welch ANOVA test | Result |
|---|---|---|
| k = 1 and k = 2 | 0.62657 | Accept |
| k = 2 and k = 3 | 0.36374 | Accept |
| k = 3 and k = 4 | 0.76126 | Accept |
| k = 4 and k = 5 | 0.98051 | Accept |
| k = 5 and k = 6 | 0.64154 | Accept |
| k = 6 and k = 7 | 0.88089 | Accept |
| k = 7 and k = 8 | 0.45154 | Accept |
| k = 8 and k = 9 | 0.40607 | Accept |
| k = 9 and k = 10 | 0.98596 | Accept |

### S5, the Failure Mechanism Change Points are Determined, and Degradation Stages are Identified

Through Step 4, the means and variances of the MEF vector samples under different degradation phases are compared. According to the F test, the null hypothesis between \hat{M}₂ and \hat{M}₃, along with between \hat{M}₃ and \hat{M}₄, is rejected, indicating significant differences in variances, which suggests a change in the degradation mechanism within the third degradation phase. According to the Welch ANOVA test, no significant differences in means are found between this phase and the others. Considering the test results for both variance and mean, it is indicated that the mechanism change-point occurs in the third degradation phase. Accordingly, the degradation stages can be identified: degradation phases k=1-2 belong to the first degradation stage, and degradation phases k=4-10 belong to the second degradation stage.

Therefore, the present disclosure adopts the mechanism equivalence-driven method for degradation stages identification and change points detection, by collecting and preprocessing the degradation data of the product, the degradation phases are divided according to the data, and the degradation modeling of each phase is performed based on the TEDP process. Subsequently, the normality test, Bartlett test, and ANOVA method are used to judge the mechanism equivalence of the degradation phases. Finally, the change time and degradation stage of the degradation mechanism are identified, compared with the traditional method, the present disclosure ensures robustness of the degradation model while achieving more accurate identification of product degradation stages. The present disclosure has strong operability and is suitable for performance degradation modeling, life prediction, and failure analysis of various products.

Finally, it should be explained that the above embodiments are only used to explain the technical scheme of the present disclosure rather than restrict it. Although the present disclosure is described in detail with reference to the better embodiment, the ordinary technical personnel in this field should understand that they can still modify or replace the technical scheme of the present disclosure, and these modifications or equivalent substitutions cannot make the modified technical scheme out of the spirit and scope of the technical scheme of the present disclosure.

What is claimed is:

1. A mechanism equivalence-driven method for degradation stages identification and change points detection, comprising:
S1, preprocessing degradation data of a product and dividing degradation phases;
S2, calculating a mechanical equivalence factor (MEF) of each degradation phase;
S3, constructing hypothesis testing samples and performing a normality test on the samples;
S4, performing test for equivalence of variances and means;
S5, determining failure mechanism change points and identifying degradation stages.

2. The mechanism equivalence-driven method for degradation stages identification and change points detection according to claim 1, wherein step S1 specifically comprises:
it is assumed that degradation data of n products are collected and divided into k degradation phases according to time series, each degradation phase is measured c times, h=1, 2, . . . , c; the degradation phase is denoted as i, i=1, 2, . . . , k, a product serial number is denoted as j, j=1, 2, . . . , n, a historical monitoring time and a corresponding degradation path are denoted as T_{0→x}={t₀, t₁, . . . , tₓ} and Y_{0→x}={y₀, y₁, . . . , yₓ}, respectively, wherein tₓᵢ denotes a start or end time of each degradation phase, and yₓᵢ=Y (tₓᵢ);
isotonic regression and single exponential smoothing method are employed for data preprocessing, the single exponential smoothing method provides a predicted value at time t+1 by computing a weighted average of an actual observation value and a predicted value at time t, with a prediction formula given as follows:
$${F}_{t + 1} = ε {Y}_{t} + ( 1 - ε ) {F}_{t} \qquad ( 1 )$$
wherein Yₜ denotes the actual observation value at time t; Fₜ denotes the predicted value at time t; ε denotes a smoothing coefficient.

3. The mechanism equivalence-driven method for degradation stages identification and change points detection according to claim 2, wherein step S2 specifically comprises:
S21, a degradation model is performed based on a Tweedie exponential dispersion process (TEDP) according to the degradation data;
S22, a definition of MEF is obtained by combining an accelerating factor invariant principle with the TEDP process;
S23, a maximum likelihood estimation method, is used to estimate parameters required for calculating the MEF.

4. The mechanism equivalence-driven method for degradation stages identification and change points detection according to claim 3, wherein step S21 is specified as follows: Let {Y(t), t≥0} be an observed product degradation path, and let Δtᵢ=tᵢ−tᵢ₋₁ along with Δyᵢ=yᵢ−yᵢ₋₁, due to complexity of a TEDP model, a distribution of degradation increment f(Δy; μ, λ, r) has no exact analytical expression. However, a saddle-point approximation method is used, and an approximate expression for the degradation increment f(Δy; μ, y, r) can be given when ΔΔt→∞ as follows:
$$f ( Δ y ; μ , λ ) = c ( Δ y ; λ , Δ t ) \cdot exp \{ λ [ Δ y \cdot ω ( μ ) - Δ t \cdot κ ( ω ( μ ) ) ] \} \qquad ( 2 )$$
wherein μ denotes a drift parameter, denotes a diffusion parameter, c(⋅) and κ(⋅) are real functions, and a mean and variance of Y(t) are μt and V(μ)t/λ, respectively, wherein μ=κ′(ω(μ)), V(μ)=κ″(w(μ)), and ω′(μ)=1/V(μ); in particular, V(μ)=μ^{r}, with r∈(−∞, 0]∪[1, ∞), is defined as a variance function, and d(Δy; Δt, μ, r) denotes a unit deviation function, which is calculated using following equations:
$$d ( Δ y ; Δ t , μ , r ) = \{ \begin{matrix}{( \frac{Δ y}{Δ t} - μ )}^{2} , r = 0 \\ 2 [ \frac{Δ y}{Δ t} log ( \frac{Δ y}{μ Δ t} ) - ( \frac{Δ y}{Δ t} - μ ) ] , r = 1 \\ 2 [ log ( \frac{μΔ t}{Δ y} ) + \frac{Δ y}{μΔ t} - 1 ] , r = 2 \\ 2 \{ \frac{[ {max ( Δ y / Δ t , 0 )}^{2 - r} ]}{( 1 - r ) ( 2 - r )} - \frac{{μ}^{1 - r} Δ y}{( 1 - r ) Δ t} + \frac{{μ}^{2 - r}}{2 - r} \} , r \neq 0 , 1 , 2\end{matrix} . \qquad ( 3 )$$

5. The mechanism equivalence-driven method for degradation stages identification and change points detection according to claim 4, wherein in step S22, the MEF can be defined as follows:
$$m = \frac{λ}{{μ}^{r - 1}} . \qquad ( 4 )$$

6. The mechanism equivalence-driven method for degradation stages identification and change points detection according to claim 5, wherein a log-likelihood function of the product degradation path in step S23 is:
$$lnL ( ϒ , Θ ) = {\sum }_{i = 1}^{k} {\sum }_{j = 1}^{n} {\sum }_{h = 1}^{c} I n f ( Δ {y}_{ijh} ; {μ}_{i} , {λ}_{i} , {r}_{i} ) = {\sum }_{i = 1}^{k} ( \frac{n c}{2} ln \frac{λ}{2 π} ) - {\sum }_{i = 1}^{k} {\sum }_{j = 1}^{n} {\sum }_{h = 1}^{c} ( \frac{1 - r}{2} ln Δ {t}_{ijh} + \frac{r}{2} ln Δ {y}_{ijh} ) - {\sum }_{i = 1}^{k} {\sum }_{j = 1}^{n} {\sum }_{h = 1}^{c} ( \frac{{λ}_{i} Δ {t}_{ijh}}{2} d ( Δ {y}_{ijh} ; Δ {t}_{ijh} , {μ}_{i} ) ) \qquad ( 5 )$$
By calculating a partial derivative of Equation (5), estimation equations of parameters μᵢ and λᵢ are obtained:
$${\hat{μ}}_{i} = \frac{{\sum }_{j = 1}^{n} {\sum }_{h = 1}^{c} Δ {y}_{ijh}}{{\sum }_{j = 1}^{n} {\sum }_{h = 1}^{c} Δ {t}_{ijh}} \qquad ( 6 )$$
$${\hat{λ}}_{i} = \frac{nc}{{\sum }_{j = 1}^{n} {\sum }_{h = 1}^{c} Δ {t}_{ijh} d ( Δ {y}_{ijh} ; Δ {t}_{ijh} , {\hat{μ}}_{i} )} \qquad ( 7 )$$
\hat{μ}ᵢ and \hat{λ}ᵢ are substituted into Equation (5), its maximum extreme point is solved, and \hat{r}ᵢ is obtained.

7. The mechanism equivalence-driven method for degradation stages identification and change points detection according to claim 6, wherein step S3 specifically comprises:
parameters of each phase and each product are estimated, respectively, and a MEF vector sample is constructed as follows:
$${\hat{M}}_{i} = ( {\hat{M}}_{i 1} , {\hat{M}}_{i 2} , ⋯ , {\hat{M}}_{i n} ) \qquad ( 8 )$$
Wherein \hat{M}ᵢⱼ denotes a MEF for an i-th degradation phase estimated based on a j-th product, let \hat{M}₁, . . . , \hat{M}ᵢ, . . . , \hat{M}ₖ be the hypothesis testing samples. Since the products within each degradation phase belong to a same batch, elements in the vector \hat{M}ᵢ are considered to come from a same population distribution, and it is assumed that the elements are independent of each other, and there is no correlation between different population distributions. Based on the above assumptions, the means and variances are used to test whether there are significant differences between different population distributions, thereby determining whether the degradation mechanism has changed;
a Shapiro-Wilk (S-W) test in SPSS software is used to test whether \hat{M}ᵢ₁, \hat{M}ᵢ₂, . . . , \hat{M}ᵢₙ obey the normal distribution.

8. The mechanism equivalence-driven method for degradation stages identification and change points detection according to claim 7, wherein step S4 specifically comprises:
when the S-W test is accepted, \hat{M}ᵢ₁, \hat{M}ᵢ₂, . . . , \hat{M}ᵢₙ are considered to follow the normal distribution. degradation phases that do not pass the S-W test are removed, and remaining samples are tested for mechanism equivalence. For an i-th degradation phase that follows the normal distribution, an unbiased estimation of mean and variance is obtained by using following equations, wherein i=1, 2, . . . , k′:
$${\overline{p}}_{i} = \frac{1}{n} {\sum }_{j = 1}^{n} {\hat{M}}_{ij} \qquad ( 9 )$$
$${\overline{q}}_{i}^{2} = \frac{1}{n - 1} {\sum }_{j = 1}^{n} {( {\hat{M}}_{ij} - {p}_{i} )}^{2} \qquad ( 10 )$$
Further test whether distributions of the samples of the MEF vector from different degradation phases are equivalent; firstly, a Bartlett test is used to evaluate a variance equivalence, a null hypothesis of equal variance is denoted as
$${H}_{0} : {q}_{1}^{2} = {q}_{2}^{2} = ⋯ = {q}_{k}^{2} ,$$
and the Bartlett statistic is constructed as:
$$B = \frac{ν ln ( {\overline{q}}^{2} ) - {\sum }_{i = 1}^{k} {ν}_{i} ln ( {\overline{q}}_{i}^{2} )}{1 + \frac{1}{3 ( k - 1 )} ( {\sum }_{i = 1}^{k} \frac{1}{{ν}_{i}} - \frac{1}{ν} )} \qquad ( 11 )$$
Wherein
$${\overline{q}}^{2} = [ {\sum }_{i = 1}^{k} {v}_{i} {\overline{q}}_{i}^{2} ] / v , {v}_{i} = n - 1 , v = {\sum }_{i = 1}^{k} {v}_{i} ;$$
at a significance level a, the rejection region is:
$${Ω}_{Bart} = \{ B \geq {χ}_{α}^{2} ( k - 1 ) \} \qquad ( 12 )$$
a F test can be performed sequentially between adjacent degradation phases until a specific location of the degradation mechanism change is determined;
subsequently, analysis of variances (ANOVA) is used to test an equivalence of the mean values of the samples within each degradation phase, if the F test finds that there are significant differences in the variances of some phases, a Welch ANOVA method can be used to test the equivalence of the mean, by calculating a p value of Welch ANOVA, it is judged whether there is a significant difference in the mean value of each degradation phase.

9. The mechanism equivalence-driven method for degradation stages identification and change points detection according to claim 8, wherein in step S5, the means and variances of the MEF vector samples obtained in S4 under different degradation phases are compared, if there is a significant difference between overall distributions of the means or variances, it is considered that the degradation mechanism of the product in one or several degradation phases has changed; otherwise, it is considered that the degradation mechanism of the product has not changed, based on this, a location of the mechanism change-point is determined and degradation stages under different degradation mechanisms are identified.
